(19) United States
(12) Patent Application Publication
(10) Pub. No.: US 2019/0370659 A1
(43) Pub. Date: Dec. 5, 2019

(54) OPTIMIZING NEURAL NETWORK ARCHITECTURES

(71) Applicant: Google LLC, Mountain View, CA (US)

(72) Inventors: Jeffrey Adgate Dean, Palo Alto, CA (US); Sherry Moore, Los Altos, CA (US); Esteban Alberto Real, Sunnyvale, CA (US); Thomas M. Breuel, Sparks, NV (US)

(21) Appl. No.: 16/540,558

(22) Filed: Aug. 14, 2019

Related U.S. Application Data
(63) Continuation of application No. PCT/US2018/019501, filed on Feb. 23, 2018.
(60) Provisional application No. 62/462,846, filed on Feb. 23, 2017.
(60) Provisional application No. 62/462,840, filed on Feb. 23, 2017.

(51) Int. Cl. G06N 3/08; G06N 20/00; G06K 9/62; G06F 11/34

(52) U.S. Cl. CPC G06N 3/082; G06F 11/3495; G06K 9/6256; G06N 20/00

(57) ABSTRACT

Methods, systems, and apparatus, including computer programs encoded on a computer storage medium, for optimizing neural network architectures. One of the methods includes receiving training data; determining, using the training data, an optimized neural network architecture for performing the machine learning task; and determining trained values of parameters of a neural network having the optimized neural network architecture.

### CROSS-REFERENCE TO RELATED APPLICATIONS

This application is a continuation of and claims priority to PCT Application No. PCT/US2018/019501, filed on Feb. 23, 2018, which claims priority to U.S. Provisional Application No. 62/462,846, filed on Feb. 23, 2017, and U.S. Provisional Application No. 62/462,840, filed on Feb. 23, 2017. The disclosures of the prior applications are considered part of and are incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

In general, one innovative aspect of the subject matter described in this specification can be embodied in methods for determining an optimal neural network architecture.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The subject matter described in this specification can be implemented in particular embodiments so as to realize one or more of the following advantages. By optimizing a neural network architecture using training data for a given machine learning task as described in this specification, the performance of the final, trained neural network on the machine learning task can be improved. In particular, the architecture of the neural network can be tailored to the training data for the task without being constrained by pre-existing architectures, improving the performance of the trained neural network. By distributing the optimization of the architecture across multiple worker computing units, the search space of possible architectures that can be searched and evaluated is greatly increased, resulting in the final optimized architecture having improved performance on the machine learning task. Additionally, by operating on compact representations of the architectures rather than directly needing to modify the neural network, the efficiency of the optimization process is improved, resulting in the optimized architecture being determined more quickly, being determined while using fewer computing resources, e.g., less memory and processing power, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network architecture optimization system.

FIG. 2 is a flow chart of an example process for optimizing a neural network architecture.

FIG. 3 is a flow chart of an example process for updating the compact representations in the population repository.

### DETAILED DESCRIPTION

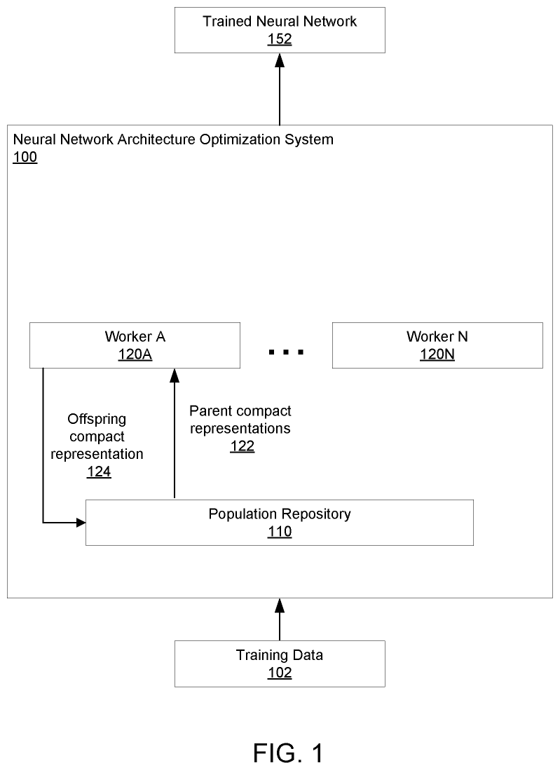

FIG. 1 shows an example neural network architecture optimization system 100. The neural network architecture optimization system 100 is an example of a system implemented as computer programs on one or more computers in one or more locations, in which the systems, components, and techniques described below can be implemented.

The neural network architecture optimization system 100 is a system that receives, i.e., from a user of the system, training data 102 for training a neural network to perform a machine learning task and uses the training data 102 to determine an optimal neural network architecture for performing the machine learning task and to train a neural network having the optimal neural network architecture to determine trained values of parameters of the neural network.

The training data 102 generally includes multiple training examples and a respective target output for each training example. The target output for a given training example is the output that should be generated by the trained neural network by processing the given training example.

The system 100 can receive the training data 102 in any of a variety of ways. For example, the system 100 can receive training data as an upload from a remote user of the system over a data communication network, e.g., using an application programming interface (API) made available by the system 100. As another example, the system 100 can receive an input from a user specifying which data that is already maintained by the system 100 should be used as the training data 102.

The neural network architecture optimization system 100 generates data 152 specifying a trained neural network using the training data 102. The data 152 specifies an optimal architecture of a trained neural network and trained values of the parameters of a trained neural network having the optimal architecture.

Once the neural network architecture optimization system 100 has generated the data 152, the neural network architecture optimization system 100 can instantiate a trained neural network using the trained neural network data 152 and use the trained neural network to process new received inputs to perform the machine learning task, e.g., through the API provided by the system. That is, the system 100 can receive inputs to be processed, use the trained neural network to process the inputs, and provide the outputs generated by the trained neural network or data derived from the generated outputs in response to the received inputs. Instead or in addition, the system 100 can store the trained neural network data 152 for later use in instantiating a trained neural network, or can transmit the trained neural network data 152 to another system for use in instantiating a trained neural network, or output the data 152 to the user that submitted the training data.

The machine learning task is a task that is specified by the user that submits the training data 102 to the system 100.

In some implementations, the user explicitly defines the task by submitting data identifying the task to the neural network architecture optimization system 100 with the training data 102. For example, the system 100 may present a user interface on a user device of the user that allows the user to select the task from a list of tasks supported by the system 100. That is, the neural network architecture optimization system 100 can maintain a list of machine learning tasks, e.g., image processing tasks like image classification, speech recognition tasks, natural language processing tasks like sentiment analysis, and so on. The system 100 can allow the user to select one of the maintained tasks as the task for which the training data is to be used by selecting one of the tasks in the user interface.

In some other implementations, the training data 102 submitted by the user specifies the machine learning task. That is, the neural network architecture optimization system 100 defines the task as a task to process inputs having the same format and structure as the training examples in the training data 102 in order to generate outputs having the same format and structure as the target outputs for the training examples. For example, if the training examples are images having a certain resolution and the target outputs are one-thousand dimensional vectors, the system 100 can identify the task as a task to map an image having the certain resolution to a one-thousand dimensional vector. For example, the one-thousand dimensional target output vectors may have a single element with a non-zero value. The position of the non-zero value indicates which of 1000 classes the training example image belongs to. In this example, the system 100 may identify that the task is to map an image to a one-thousand dimensional probability vector. Each element represents the probability that the image belongs to the respective class. The CIFAR-1000 dataset, which consists of 50000 training examples paired with a target output classification selected from 1000 possible classes, is an example of such training data 102. CIFAR-10 is a related dataset where the classification is one of ten possible classes. Another example of suitable training data 102 is the MNIST dataset where the training examples are images of handwritten digits and the target output is the digit which these represent. The target output may be represented as a ten dimensional vector having a single non-zero value, with the position of the non-zero value indicating the respective digit.

The neural network architecture optimization system 100 includes a population repository 110 and multiple workers 120A-N that operate independently of one another to update the data stored in the population repository.

At any given time during the training, the population repository 110 is implemented as one or more storage devices in one or more physical locations and stores data specifying the current population of candidate neural network architectures.

In particular, the population repository 110 stores, for each candidate neural network architecture in the current population, a compact representation that defines the architecture. Optionally, the population repository 110 can also store, for each candidate architecture, an instance of a neural network having the architecture, current values of parameters for the neural network having the architecture, or additional metadata characterizing the architecture.

The compact representation of a given architecture is data that encodes at least part of the architecture, i.e., data that can be used to generate a neural network having the architecture or at least the portion of the neural network architecture that can be modified by the neural network architecture optimization system 100. In particular, the compact representation of a given architecture compactly identifies each layer in the architecture and the connections between the layers in the architecture, i.e., the flow of data between the layers during the processing of an input by the neural network.

For example, the compact representation can be data representing a graph of nodes connected by directed edges. Generally, each node in the graph represents a neural network component, e.g., a neural network layer, a neural network module, a gate in a long-short-term memory cell (LSTM), an LSTM cell, or other neural network component, in the architecture and each edge in the graph connects a respective outgoing node to a respective incoming node and represents that at least a portion of the output generated by the component represented by the outgoing node is provided as input to the layer represented by the incoming node. Nodes and edges have labels that characterize how data is transformed by the various components for the architecture.

In the example of a convolutional neural network, each node in the graph represents a neural network layer in the architecture and has a label that specifies the size of the input to the layer represented by the node and the type of activation function, if any, applied by the layer represented by the node and the label for each edge specifies a transformation that is applied by the layer represented by the incoming node to the output generated by the layer represented by the outgoing node, e.g., a convolution or a matrix multiplication as applied by a fully-connected layer.

As another example, the compact representation can be a list of identifiers for the components in the architecture arranged in an order that reflects connections between the components in the architecture.

As yet another example, the compact representation can be a set of rules for constructing the graph of nodes and edges described above, i.e., a set of rules that when executed results in the generation of a graph of nodes and edges that represents the architecture.

In some implementations, the compact representation also encodes data specifying hyperparameters for the training of a neural network having the encoded architecture, e.g., the learning rate, the learning rate decay, and so on.

To begin the training process, the neural network architecture optimization system 100 pre-populates the population repository with compact representations of one or more initial neural network architectures for performing the user-specified machine learning task.

Each initial neural network architecture is an architecture that receives inputs that conform to the machine learning task, i.e., inputs that have the format and structure of the training examples in the training data 102, and generates outputs that conform to the machine learning task, i.e., outputs that have the format and structure of the target outputs in the training data 102.

In particular, the neural network architecture optimization system 100 maintains data identifying multiple pre-existing neural network architectures.

In implementations where the machine learning tasks are selectable by the user, the system 100 also maintains data associating each of the pre-existing neural network architectures with the task that those architectures are configured to perform. The system can then pre-populate the population repository 110 with the pre-existing architectures that are configured to perform the user-specified task.

In implementations where the system 100 determines the task from the training data 102, the system 100 determines which architectures identified in the maintained data receive conforming inputs and generate conforming outputs and selects those architectures as the architectures to be used to pre-populate the repository 100.

In some implementations, the pre-existing neural network architectures are basic architectures for performing particular machine learning tasks. In other implementations, the pre-existing neural network architectures are architectures that, after being trained, have been found to perform well on particular machine learning tasks.

Each of the workers 120A-120N is implemented as one or more computer programs and data deployed to be executed on a respective computing unit. The computing units are configured so that they can operate independently of each other. In some implementations, only partial independence of operation is achieved, for example, because workers share some resources. A computing unit may be, e.g., a computer, a core within a computer having multiple cores, or other hardware or software within a computer capable of independently performing the computation for a worker.

Each of the workers 120A-120N iteratively updates the population of possible neural network architectures in the population repository 102 to improve the fitness of the population.

In particular, at each iteration, a given worker 120A-120N samples parent compact representations 122 from the population repository, generates an offspring compact representation 124 from the parent compact representations 122, trains a neural network having the architecture defined by the offspring compact representation 124, and stores the offspring compact representation 124 in the population repository 110 in association with a measure of fitness of the trained neural network having the architecture.

After termination criteria for the training have been satisfied, the neural network architecture optimization system 100 selects an optimal neural network architecture from the architectures remaining in the population or, in some cases, from all of the architectures that were in the population at any point during the training.

In particular, in some implementations, the neural network architecture optimization system 100 selects the architecture in the population that has the best measure of fitness. In other implementations, the neural network architecture optimization system 100 tracks measures of fitness for architectures even after those architectures are removed from the population and selects the architecture that has the best measure of fitness using the tracked measures of fitness.

To generate the data 152 specifying the trained neural network, the neural network architecture optimization system 100 can then either obtain the trained values for the parameters of a trained neural network having the optimal neural network architecture from the population repository 110 or train a neural network having the optimal architecture to determine trained values of the parameters of the neural network.

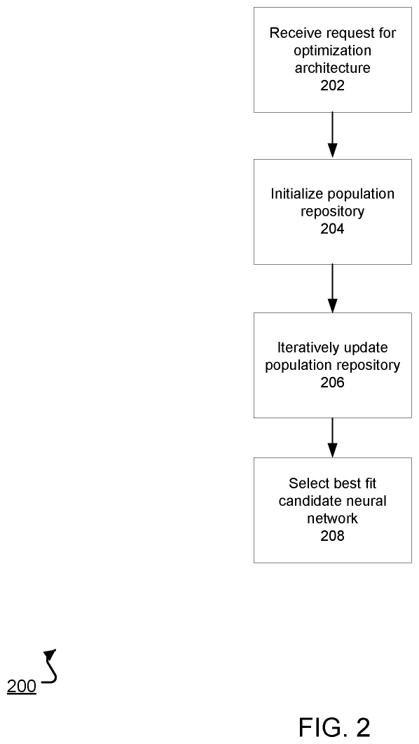

FIG. 2 is a flow chart of an example process 200 for determining an optimal neural network architecture for performing a machine learning task. For convenience, the process 200 will be described as being performed by a system of one or more computers located in one or more locations. For example, a neural network architecture optimization system, e.g., the neural network architecture optimization system 100 of FIG. 1, appropriately programmed in accordance with this specification, can perform the process 200.

The system obtains training data for use in training a neural network to perform a user-specified machine learning task (step 202). The system divides the received training data into a training subset, a validation subset, and, optionally, a test subset.

The system initializes a population repository with one or more default neural network architectures (step 204). In particular, the system initializes the population repository by adding a compact representation for each of the default neural network architectures to the population repository.

The default neural network architectures are predetermined architectures for carrying out the machine learning task, i.e., architectures that receive inputs conforming to those specified by the training data and generate outputs conforming to those specified by the training data.

The system iteratively updates the architectures in the population repository using multiple workers (step 206).

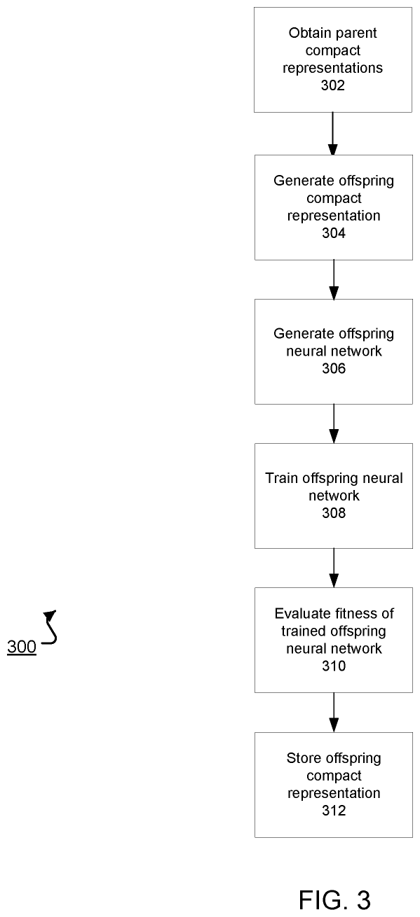

In particular, each worker of the multiple workers independently performs multiple iterations of an architecture modification process. At each iteration of the process, each worker updates the compact representations in the population repository to update the population of candidate neural network architectures. Each time a worker updates the population repository to add new compact representation for a new neural network architecture, the worker also stores a measure of fitness of a trained neural network having the neural network architecture in association with the new compact representation in the population repository. Performing an iteration of the architecture modification process is described below with reference to FIG. 3.

The system selects the best fit candidate neural network architecture as the optimized neural network architecture to be used to carry out the machine learning task (step 208). That is, once the workers are done performing iterations and termination criteria have been satisfied, e.g., after more than a threshold number of iterations have been performed or after the best fit candidate neural network in the population repository has a fitness that exceeds a threshold, the system selects the best fit candidate neural network architecture as the final neural network architecture be used in carrying out the machine learning task.

In implementations where the system generates a test subset from the training data, the system also tests the performance of a trained neural network having the optimized neural network architecture on the test subset to determine a measure of fitness of the trained neural network on the user-specified machine learning task. The system can then provide the measure of fitness for presentation to the user that submitted the training data or store the measure of fitness in association with the trained values of the parameters of the trained neural network.

Using the described method, a resultant trained neural network is able to achieve performance on a machine learning task competitive with or exceeding state-of-the-art hand-designed models while requiring little or no input from a neural network designer. In particular, the described method automatically optimizes hyperparameters of the resultant neural network.

FIG. 3 is a flow chart of an example process 300 for updating the compact representations in the population repository. For convenience, the process 300 will be described as being performed by a system of one or more computers located in one or more locations. For example, a neural network architecture optimization system, e.g., the neural network architecture optimization system 100 of FIG. 1, appropriately programmed in accordance with this specification, can perform the process 300.

The process 300 can be repeatedly independently performed by each worker of multiple workers as part of determining the optimal neural network architecture for carrying out a machine learning task.

The worker obtains multiple parent compact representations from the population repository (step 302). In particular, the worker, randomly and independently of each other worker, samples two or more compact representations from the population repository, with each sampled compact representation encoding a different candidate neural network architecture.

In some implementations, each worker always samples the same predetermined numbers of parent compact representations from the population repository, e.g., always samples two parent compact representations or always samples three compact representations. In some other implementations, each worker samples a respective predetermined number of parent compact representations from the population repository, but the predetermined number is different for different workers, e.g., one worker may always sample two parent compact representations while another worker always samples three compact representations. In yet other implementations, each worker maintains data defining a likelihood for each of multiple possible numbers and selects the number of compact representations to sample at each iteration in accordance with the likelihoods defined by the data.

The worker generates an offspring compact representation from the parent compact representations (step 304).

In particular, the worker evaluates the fitness of each of the architectures encoded by the parent compact representations and determines the parent compact representation that encodes the least fit architecture, i.e., the parent compact representation that encodes the architecture that has the worst measure of fitness.

That is, the worker compares the measures of fitness that are associated with each parent compact representation in the population repository and identifies the parent compact representation that is associated with the worst measure of fitness.

If one of the parent compact representations is not associated with a measure of fitness in the repository, the worker evaluates the fitness of a neural network having the architecture encoded by the parent compact representation as described below.

The worker then generates the offspring compact representation from the remaining parent compact representations i.e. those representations having better fitness measures. Sampling a given number of items and selecting those that perform better may be referred to as ‘tournament selection’. The parent compact representation having the worst measure of fitness may be removed from the population repository.

The workers are able to operate asynchronously in the above implementations for at least the reasons set out below. As a limited number of parent compact representations are sampled by each worker, a given worker is not normally affected by modifications to the other parent compact representations contained in the population repository. Occasionally, another worker may modify the parent compact representation that the given worker is operating on. In this case, the affected worker can simply give up and try again, i.e., sample new parent compact representations from the current population. Asynchronously operating workers are able to operate on massively-parallel, lock-free infrastructure.

If there is a single remaining parent compact representation, the worker mutates the parent compact representation to generate the offspring compact representation.

In some implementations, the worker mutates the parent compact representation by processing the parent compact representation through a mutation neural network. The mutation neural network is a neural network that has been trained to receive an input that includes one compact representation and to generate an output that defines another compact representation that is different than the input compact representation.

In some other implementations, the worker maintains data identifying a set of possible mutations that can be applied to a compact representation. The worker can randomly select one of the possible mutations and apply the mutation to the parent compact representation.

The set of possible mutations can include any of a variety of compact representation modifications that represent the addition, removal, or modification of a component from a neural network or a change in a hyperparameter for the training of the neural network.

For example, the set of possible mutations can include a mutation that removes a node from the parent compact representation and thus removes a component from the architecture encoded by the parent compact representation.

As another example, the set of possible mutations can include a mutation that adds a node to the parent compact representation and thus adds a component to the architecture encoded by the parent compact representation.

As another example, the set of possible mutations can include one or more mutations that change the label for an existing node or edge in the compact representation and thus modify the operations performed by an existing component in the architecture encoded by the parent compact representation. For example, one mutation might change the filter size of a convolutional neural network layer. As another example, another mutation might change the number of output channels of a convolutional neural network layer.

As another example, the set of possible mutations can include a mutation that modifies the learning rate used in training the neural network having the architecture or modifies the learning rate decay used in training the neural network having the architecture.

In these implementations, once the system has selected a mutation to applied to the compact representation, the system determines valid locations in the compact representation, randomly selects one of the valid locations, and then applies the mutation at the randomly selected valid location. A valid location is a location where, if the mutation was applied at the location, the compact representation would still encode a valid architecture. A valid architecture is an architecture that still performs the machine learning task, i.e., processes a conforming input to generate a conforming output.

If there are multiple remaining parent compact representations, the worker recombines the parent compact representations to generate the offspring compact representation.

In some implementations, the worker recombines the parent compact representations by processing the parent compact representations using a recombining neural network. The recombining neural network is a neural network that has been trained to receive an input that includes the parent compact representations and to generate an output that defines a new compact representation that is a recombination of the parent compact representations.

In some other implementations, the system recombines the parent compact representations by joining the parent compact representations to generate an offspring compact representation. For example, the system can join the compact representations by adding a node to the offspring compact representation that is connected by an incoming edge to the output nodes in the parent compact representations and represents a component that combines the outputs of the components represented by the output nodes of the parent compact representations. As another example, the system can remove the output nodes from each of the parent compact representations and then add a node to the offspring compact representation that is connected by incoming edges to the nodes that were connected by outgoing edges to the output nodes in the parent compact representations and represents a component that combines the outputs of the components represented by those nodes in the parent compact representations.

In some implementations, the worker also removes the least fit architecture from the current population. For example, the worker can associate data with the compact representation for the architecture that designates the compact representation as inactive or can delete the compact representation and any associated data from the repository.

In some implementations, the system maintains a maximum population size parameter that defines the maximum number of architectures that can be in the population at any given time, a minimum population size parameter that defines the minimum number of architectures that can be in the population at any given time, or both. The population size parameters can be defined by the user or can be determined automatically by the system, e.g., based on storage resources available to the system.

If the current number of architectures in the population is below the minimum population size parameter, the worker can refrain from removing the least fit architecture from the population.

If the current number of architectures is equal to or exceeds the maximum population size parameter, the worker can refrain from generating the offspring compact representation, i.e., can remove the least fit architecture from the population without replacing it with a new compact representation and without performing steps 306-312 of the process 300.

The worker generates an offspring neural network by decoding the offspring compact representation (step 306). That is, the worker generates a neural network having the architecture encoded by the offspring compact representation.

In some implementations, the worker initializes the parameters of the offspring neural network to random values or predetermined initial values. In other implementations, the worker initializes the values of the parameters of those components of the offspring neural network also included in the one or more parent compact representations used to generate the offspring compact representation to the values of the parameters from the training of the corresponding parent neural networks. Initializing the values of the parameters of the components based on those included in the one or more parent compact representations may be referred to as ‘weight inheritance’.

The worker trains the offspring neural network to determine trained values of the parameters of the offspring neural network (step 308). It is desirable that offspring neural networks are completely trained. However, training the offspring neural networks to completion on each iteration of the process 300 is likely to require an unreasonable amount of time and computing resources, at least for larger neural networks. Weight inheritance may resolve this dilemma by enabling the offspring networks on later iterations to be fully trained, or be at least close to fully trained, while limiting the amount of training required on each iteration of the process 300.

In particular, the worker trains the offspring neural network on the training subset of the training data using a neural network training technique that is appropriate for the machine learning task, e.g., stochastic gradient descent with backpropagation or, if the offspring neural network is a recurrent neural network, a backpropagation-through-time training technique. During the training, the worker performs the training in accordance with any training hyperparameters that are encoded by the offspring compact representation.

In some implementations, the worker modifies the order of the training examples in the training subset each time the worker trains a new neural network, e.g., by randomly ordering the training examples in the training subset before each round of training. Thus, each worker generally trains neural networks on the same training examples, but ordered differently from each other worker.

The worker evaluates the fitness of the trained offspring neural network (step 310).

In particular, the system can determine the fitness of the trained offspring neural network on the validation subset, i.e., on a subset that is different from the training subset the worker uses to train the offspring neural network.

The worker evaluates the fitness of the trained offspring neural network by evaluating the fitness of the model outputs generated by the trained neural network on the training examples in the validation subset using the target outputs for those training examples.

In some implementations, the user specifies the measure of fitness to be used in evaluating the fitness of the trained offspring neural networks, e.g., an accuracy measure, a recall measure, an area under the curve measure, a squared error measure, a perplexity measure, and so on.

In other implementations, the system maintains data associating a respective fitness measure with each of the machine learning tasks that are supported by the system, e.g., a respective fitness measure with each machine learning task that is selectable by the user. In these implementations, the system instructs each worker to use the fitness measure that is associated with the user-specified machine learning task.

The worker stores the offspring compact representation and the measure of fitness of the trained offspring neural network in the population repository (step 312). In some implementations, the worker also stores the trained values of the parameters of the trained neural network in the population repository in association with the offspring compact representation.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving training data for training a neural network to perform a machine learning task, the training data comprising a plurality of training examples and a respective target output for each of the training examples;
determining, using the training data, an optimized neural network architecture for performing the machine learning task, comprising:
repeatedly performing the following operations using each of a plurality of worker computing units each operating asynchronously from each other worker computing unit:
selecting, by the worker computing unit, a plurality of compact representations from a current population of compact representations in a population repository, wherein each compact representation in the current population encodes a different candidate neural network architecture for performing the machine learning task,
generating, by the worker computing unit, a new compact representation from the selected plurality of compact representations,
determining, by the worker computing unit, a measure of fitness of a trained neural network having an architecture encoded by the new compact representation, and
adding, by the worker computing unit, the new compact representation to the current population in the population repository and associating the new compact representation with the measure of fitness; and
selecting, as the optimized neural network architecture, the neural network architecture that is encoded by the compact representation that is associated with a best measure of fitness; and
determining trained values of parameters of a neural network having the optimized neural network architecture.

2. The method of claim 1, wherein determining a measure of fitness of a trained neural network having an architecture encoded by the new compact representation comprises:
instantiating a new neural network having the architecture encoded by the new compact representation;
training the new neural network on a training subset of the training data to determine trained values of parameters of the new neural network; and
determining the measure of fitness by evaluating a performance of the trained new neural network on a validation subset of the training data.

3. The method of claim 2, the operations further comprising:
associating the trained values of the parameters of the new neural network with the new compact representation in the population repository.

4. The method of claim 3, wherein determining trained values of parameters of a neural network having the optimized neural network architecture comprises:
selecting, as the trained values of the parameters of the neural network having the optimized neural network architecture, trained values that are associated with the compact representation that is associated with the best measure of fitness.

5. The method of claim 1, further comprising:
initializing the population repository with one or more default compact representations that encode default neural network architectures for performing the machine learning task.

6. The method of claim 1, wherein generating a new compact representation from the plurality of compact representations comprises:
identifying a compact representation of the plurality of compact representations that is associated with a worst fitness; and
generating the new compact representation from the one or more compact representations other than the identified compact representation in the plurality of compact representations.

7. The method of claim 6, the operations further comprising:
removing the identified compact representation from the current population.

8. The method of claim 6, wherein there is one remaining compact representation other than the identified compact representation in the plurality of compact representations, and wherein generating the new compact representation comprises:
modifying the one remaining compact representation to generate the new compact representation.

9. The method of claim 8, wherein modifying the one remaining compact representation comprises:
randomly selecting a mutation from a predetermined set of mutations; and
applying the randomly selected mutation to the one remaining compact representation to generate the new compact representation.

10. The method of claim 8, wherein modifying the one remaining compact representation comprises:
processing the one remaining compact representation using a mutation neural network, wherein the mutation neural network has been trained to process a network input comprising the one remaining compact representation to generate the new compact representation.

11. The method of claim 6, wherein there are a plurality of remaining compact representations other than the identified compact representation in the plurality of compact representations, and wherein generating the new compact representation comprises:
combining the plurality of remaining compact representations to generate the new compact representation.

12. The method of claim 11, wherein combining the plurality of remaining compact representations to generate the new compact representation comprises:
joining the remaining compact representations to generate the new compact representation.

13. The method of claim 11, wherein combining the plurality of remaining compact representations to generate the new compact representation comprises:
processing the remaining compact representations using a recombination neural network, wherein the recombination neural network has been trained to process a network input comprising the remaining compact representations to generate the new compact representation.

14. The method of claim 1, further comprising:
using the neural network having the optimized neural network architecture to process new input examples in accordance with the trained values of the parameters of the neural network.

15. A system comprising one or more computers and one or more non-transitory storage devices storing instructions that, when executed by the one or more computers, cause the one or more computers to perform operations comprising:
receiving training data for training a neural network to perform a machine learning task, the training data comprising a plurality of training examples and a respective target output for each of the training examples;
determining, using the training data, an optimized neural network architecture for performing the machine learning task, comprising:
repeatedly performing the following operations using each of a plurality of worker computing units each operating asynchronously from each other worker computing unit:
selecting, by the worker computing unit, a plurality of compact representations from a current population of compact representations in a population repository, wherein each compact representation in the current population encodes a different candidate neural network architecture for performing the machine learning task,
generating, by the worker computing unit, a new compact representation from the selected plurality of compact representations,
determining, by the worker computing unit, a measure of fitness of a trained neural network having an architecture encoded by the new compact representation, and
adding, by the worker computing unit, the new compact representation to the current population in the population repository and associating the new compact representation with the measure of fitness; and
selecting, as the optimized neural network architecture, the neural network architecture that is encoded by the compact representation that is associated with a best measure of fitness; and
determining trained values of parameters of a neural network having the optimized neural network architecture.

16. The system of claim 15, wherein determining a measure of fitness of a trained neural network having an architecture encoded by the new compact representation comprises:
instantiating a new neural network having the architecture encoded by the new compact representation;
training the new neural network on a training subset of the training data to determine trained values of parameters of the new neural network; and
determining the measure of fitness by evaluating a performance of the trained new neural network on a validation subset of the training data.

17. The system of claim 16, wherein the operations that are repeatedly performed using each of a plurality of worker computing units further comprises:
associating the trained values of the parameters of the new neural network with the new compact representation in the population repository.

18. The system of claim 17, wherein determining trained values of parameters of a neural network having the optimized neural network architecture comprises:
selecting, as the trained values of the parameters of the neural network having the optimized neural network architecture, trained values that are associated with the compact representation that is associated with the best measure of fitness.

19. The system of claim 15, wherein generating a new compact representation from the plurality of compact representations comprises:
identifying a compact representation of the plurality of compact representations that is associated with a worst fitness; and
generating the new compact representation from the one or more compact representations other than the identified compact representation in the plurality of compact representations.

20. One or more non-transitory computer storage media encoded with instructions that, when executed by one or more computers, cause the one or more computers to perform operations comprising:
receiving training data for training a neural network to perform a machine learning task, the training data comprising a plurality of training examples and a respective target output for each of the training examples;
determining, using the training data, an optimized neural network architecture for performing the machine learning task, comprising:
repeatedly performing the following operations using each of a plurality of worker computing units each operating asynchronously from each other worker computing unit:
selecting, by the worker computing unit, a plurality of compact representations from a current population of compact representations in a population repository, wherein each compact representation in the current population encodes a different candidate neural network architecture for performing the machine learning task,
generating, by the worker computing unit, a new compact representation from the selected plurality of compact representations,
determining, by the worker computing unit, a measure of fitness of a trained neural network having an architecture encoded by the new compact representation, and
adding, by the worker computing unit, the new compact representation to the current population in the population repository and associating the new compact representation with the measure of fitness; and
selecting, as the optimized neural network architecture, the neural network architecture that is encoded by the compact representation that is associated with a best measure of fitness; and
determining trained values of parameters of a neural network having the optimized neural network architecture.
